(19) United States
(12) Patent Application Publication
(10) Pub. No.: US 2006/0135636 A1
(43) Pub. Date: Jun. 22, 2006

(54) Isocyanate-based polymer foams with nano-scale materials

(75) Inventors: Zhen Zhu, East Norriton, PA (US); David J. Williams, East Amherst, NY (US); Caroline R. Bibb, Randolph, NJ (US)

Correspondence Address: Honeywell International Inc., Patent Services Group AB2, P.O. Box 2245, Morristown, NJ, 07962, US

(73) Assignee: HONEYWELL INTERNATIONAL INC.

(21) Appl. No.: 11/274,553

(22) Filed: Nov. 15, 2005

Related U.S. Application Data
(60) Provisional application No. 60/627,916, filed on Nov. 15, 2004.

(51) Int. Cl. C08G 18/00

(52) U.S. Cl. 521/172

(57) ABSTRACT

Isocyante-based polymer foams containing functionalized nano-scale materials in which the functional groups are OH, NH₂, COOH or NCO groups. The incorporation of such functionalized nano-scale materials into the isocyanate-based polymer foams provides foams with improved properties such as insulation values, mechanical properties and flame retardancy performance properties, including but not limited to k-factor and dimensional stability.

### RELATED APPLICATIONS

This application claims priority under 35 U.S.C. 119 of U.S. Provisional Patent Application No. 60/627,916, filed Nov. 15, 2004.

### FIELD OF THE INVENTION

This invention relates to isocyante-based polymer foams containing functionalized nano-scale materials. The incorporation of such functionalized nano-scale materials into the isocyanate-based polymer foams provides foams with improved properties, including but not limited to k-factor and dimensional stability. The invention also relates to a method for producing such isocyante-based polymer foams containing functionalized nano-scale materials. The invention additionally relates to polymer premixes containing nano-scale materials in the premixes for producing isocyante-based polymer foams containing functionalized nano-scale materials.

### BACKGROUND TO THE INVENTION

Polymer compositions with nano sized materials have been proposed for a variety of purposes. Such disclosure are found, for example in the following documents. U.S. Pat. No. 6,518,324 of Atofina Chemicals, Inc., discloses a polymer foam or polyurethane foam with 0-10 weight % of nanoclay, based on total weight of polymer. The nanoclay has thickness of about 3-1000 Angstroms and a size in the planar direction of about 0.01 to 100 microns. Disclosed are improved foam properties included thermal insulation properties, fine cell structure and slow aging rate of the foams. WO 2003016370 of Chemiewerk Bad Koestritz G.m.b.H., discloses a stable colloidal silicic acid/polyol system was produced by replacing water in aqueous silica sols with hydroxy group-containing compounds, such as colloidal silicic acid/polyol system was produced by replacing water in aqueous silica sols with hydroxy group-containing compounds, such as polyether polyols, polyether polyester polyols, polyester polyols or their mixtures. The colloidal silicic acid/polyol compound was mixed with diphenylmethane diisocyanate to produce polyurethane foams containing 16.6% of silicic acid nano-particles. The nano-scale distribution of the silicic acid in the composites determines the technically valuable properties of the inorganic-organic nanocomposites. WO 200047657 of Dow, USA relates to improved preparation of structural foam, multilayer film, sheet, or tube pultruded structural profile and compression molded article by using polymer in which multi-layered silicate material is dispersed to provide dispersions of 1, 2, 3, 4, and 5 and more of silicate material. US 20020137871 of Special Ind. Coating Co relates to a sprayable polyurethane composition comprises 0.5-30 wt. % fibrous material for coating application. The fibrous material is aramid, high molecular weight polyethylene, fullerene, nanotube, and/or ceramic fiber. WO 2002078824 of North Carolina State University, University of North Carolina at Chapel Hill, relates to thin-walled multi-layer polymeric material include a foamed layer, a transition layer, and unfoamed outer layer. The foamed layer comprises microcells, nanocells, or their combinations in a closed cell network. WO 2001021549 of UT-Battelle, LLC, relates to thermally conductive pitch-based foam composite having a particulate content of carbon fiber, carbon nanotube, or carbon particulate. The particulate alters the mechanical characteristics of the foam without severely degrading the foam thermal condition. WO 2000037242 of Magna International of America, Inc., relates to a structural foam with 2-15 vol. % reinforcing particles. The nano-particles have one or more layers of 0.7-1.2 nm thick platelets. More than 50% of the reinforcing particles are less than 20 layers thick. This material is suitable for molding into automobile trim. JP 05098059 of Lion Corp. relates to a polyethylene foam with 5-50% inorganic powdered fillers (diameter 1.5 mm) prepared through kneading foam process and stated to have good compression hardness and compression recovery and thereby particularly useful for subfloor applications. “Effect of nano- and micro-silica fillers on polyurethane foam properties”, Journal of Cellular Plastics (2002), 38(3), pp 229-239. discloses rigid or flexible polyurethane foam with 0-20 weight % of micro-silica (1.5 mm) or nano-silica (12 nm). The authors studied the foam hardness, compression strength, rebound resilience, morphology polymeric matrix and effect of filler loading level on density. “Processing and cell structure of nano-clay modified microcellular foams”, Annual Technical Conference-Society of Plastics Engineers, (2002), 60^{th} (Vol. 2), pp 1915-1919, discloses polystyrene foam with nanoclay composites. The article discloses a continuous extrusion process with CO₂ as the foaming agent and studied the effects of nanoclay particles content and dispersion on foam structure, polymer melt rheology and the foaming process. “Influences of nano-CaCO3 on mechanical properties of rigid polyurethane foam”, Zhongguo Suliao (2001), 15(8), pp 28-31, relates to rigid polyurethane foams reinforced by nano-CaCO₃ prepared through in-situ disperse ultrasonic polymerization. The polymer foam has increased compress strength and modulus, but decreased foamability and impact strength due to rapidly increased viscosity.

### SUMMARY OF INVENTION

Isocyante-based polymer foams containing certain functionalized nano-scale materials are provided by this invention wherein the incorporation of such functionalized nano-scale materials into the isocyanate-based polymer foams provides foams with improved properties such as insulation values, mechanical properties and flame retardancy performance properties, including but not limited to k-factor and dimensional stability. The invention also relates to a method for producing such isocyante-based polymer foams containing functionalized nano-scale materials. The invention additionally relates to polymer premixes containing functionalized nano-scale materials in the premixes for producing isocyante-based polymer foams containing functionalized nano-scale materials. The functionalized nano-scale materials incorporated into the isocyanate-based foams are characterized by being OH, NH₂, COOH and NCO functionalized nano-scaled materials. By dispersing these functionalized nano-sized particles in the molecular level of the polymers one obtains isocyanate-based polymer foams having improved properties. Among the properties that may be improved are dimensional stability, improved insulation values due to improved permeation barrier properties, improved flame resistance with reduced char formation and reduced smoke generated in a fire, improved flow properties, and improved adhesion strength. With the improved dimensional stability, one will be able to manufacture lower density foams and thinner foams without sacrificing structural and other properties of the foams. The thermal conductivity, or k-factor of foams prepared using the compositions of the invention is lower, hence superior, when compared to the thermal conductivity of foam prepared without those functionalized nano-scale materials. Here, K-factor is a measure of the thermal conductivity of the foam and is defined as the rate of transfer of heat through one square foot of a one inch thick material in one hour where there is a difference of one degree Fahrenheit perpendicularly across the two surfaces of the material. Another advantage with this invention is the ability of the functionalized nano-scaled materials to act as nucleating agents in the foaming process permitting one to obtain finer cell structure in the resulting foams.

The functionalized nano-scale materials may be incorporated into the foamable formulation in a wide variety of ways. For example, the nano-scaled material may be formulated with the blowing agent, with polyol premixes or with other foam reactants and raw materials, either before or during the foaming process. The amount of functionalized nano-scale marterial incorporated in the isocyanate-based fomable formulation will depend upon the specific functionalized nano-scale material to be incorporated and the purpose of such material is being incorporated in the formulation. In general, the amount of functionalized nano-scale material to be incorporated will be from about 0.1 to about 10% by weight, preferably from about −0.5 to about 5% by weight, and most preferably from about 1 to about 2% by weight, based on the weight of total foamable formulation. If the nano-scale material is incorporated into a polyol preblend reactant for reaction with an isocyanate reactant, in general, the amount of functionalized nano-scale material to be incorporated into the polyol preblend will be from about 0.2 to about 20% by weight, preferably from about 1.0 to about 10% by weight, and most preferably from about 2 to about 4% by weight, based on the weight of the polyol preblend.

### DETAILED DESCRIPTION OF THE INVENTION

The functionalized nano-scaled material useful in this invention may be any suitable form of functionalized nano-scaled materials, such as for example, nano particles, nano composites, nano-oxides, nano clays, nanotubes, and the like. The functionalized nano-scaled materials will have present in the materials functional groups that are OH, NH₂, COOH or NCO groups or mixtures of these groups. Such functionalized nano-scaled materials include a wide variety of materials. Among the numerous examples of such functionalized nano-sscaled materials there may be mentioned as examples, functionalized organo nano clays from Unicoop and Elementis Co., namely: bis(hydroxyethyl), methyl, octadecylammonium chloride treated fluoromica, particles size of about 400 nm, organo nanoclay with OH groups (Somesif MPE); polypropyleneoxide (MW=1500), methyl, diethyl ammonium chloride treated fluoromica, particles sixe of about 500 nm; mixtures of magnesium sodium fluoride silicate and alkyl (C₈₋₁₈) bis (2-hydroxyethyl)methyl ammonium ion; etc.; alumina nano particle from Sasol North America Inc. (dispal); mixture of aluminum oxide hydroxide with proprietary surface treatment of Sasol North America Inc. (Dispal); and a mixture of boehmite and 4-C10 B-sec-alkyl derivatives of benzene sulfonic acid of Sasol North America Inc. (Dispal). Escpcially preferred are the COOH functionalized nano-scale materials.

This invention is applicable to any isocyanate-based polymeric foam, such as for example, polyurethanes and polyisocyanurates foams, either flexible or rigid foams. The nano-scaled materials for the use in the compositions and methods of this invention may be any suitable OH, NH₂, COOH or NCO functionalized nano-scaled material. The nano-scaled material may contain mixtures of the functionalized groups in the nano-scaled materials. Another advantage of this invention resides in the ability to incorporate the nano-scaled materials into the compositions at the molecular level thereby avoiding the common difficulty of incorporating conventional fillers into polymer foams.

The functionalized nano-scaled material that are to be employed in the process of this invention will have a size of from about 1 to about 1000 nm, preferably from about 10 to about 700 nm, and more preferably from about 20 to about 500 nm.

The invention is applicable to any suitable isocyanate-based polymeric foam, such as rigid and flexible polyurethanes and polyisocyanurate foams. The preparation of such isocyanate-based polymeric foams is well known in the art. Such polymeric foams are prepared employing one or more polyols and one or more polyisocyanates with an appropriate blowing agents, catalysts, and other conventional reagents and additives. Further details of the conventional materials and processes employed to produce isocyante-based polymeric foams may be found in numerous patents as well as in specialized literature, such as from the monograph, by J. H., Saunders and K. C. Frisch, High polymers, volume XVI, Polyurethanes, Parts 1 and 2, Interscience Publishers, 1962 and 1984, and Kuntstoff-Hndbuch, Polyurethane, Volume VII, Carl-Hanser-Verlag, Munich, Vienna, 1^{st} and 2^{nd} editions, 1966 and 1983, incorporated herein by reference. In general, the method comprises preparing polyurethane or polyisocyanurate foams by combining an isocyanate, a polyol or mixture of polyols, a blowing agent or mixture of blowing agents, and other materials such as catalysts, surfactants, and optionally, flame retardants, colorants, or other additives.

It is convenient in many applications to provide the components for polyurethane or polyisocyanurate foams in preblended formulations. Most typically, the foam formulation is preblended into two components. The isocyanate and optionally certain surfactants and blowing agents comprise the first component, commonly referred to as the “A” or “iso” component. The polyol or polyol mixture, surfactant, catalysts, blowing agents, flame retardant, and other isocyanate reactive components comprise the second component, commonly referred to as the “B”, or “polyol” or “resin” component. Accordingly, polyurethane or polyisocyanurate foams are readily prepared by bringing together the A and B components either by hand mix for small preparations and, preferably, machine mix techniques to form blocks, slabs, laminates, pour-in-place panels and other items, spray applied foams, froths, and the like. Optionally, other ingredients such as fire retardants, colorants, auxiliary blowing agents, and even other polyols can be added as a third stream to the mix head or reaction site. Most conveniently, however, they are all incorporated into one B component as described above.

Suitable organic polyisocyanates, defined as having 2 or more isocyanate functionalities, suitable for use in preparing the isocyanate-based polymeric foams in acordance with this invention, are conventional aliphatic, cycloaliphatic, araliphatic and preferably aromatic isocyanates. Specific examples include, but are not limited to: alkylene diisocyanates with 4 to 12 carbons in the alkylene radical such as 1,12-dodecane diisocyanate, 2-ethyl-1,4-tetramethylene diisocyanate, 2-methyl-1,5-pentamethylene diisocyanate, 1,4-tetramethylene diisocyanate and preferably 1,6-hexamethylenecyclohexane diisocyanate as well as any mixtures of these isomers, 1-isocyanato-3,3,5-trimethyl-5-isocyanatomethylcyclohexane (isophorone diisocyanate), 2,4- and 2,6-hexahydrotoluene diisocyanate as well as the corresponding isomeric mixtures, 4,4′-2,2′-, and 2,4′-dicyclohexylmethane diisocyanate as well as the corresponding isomeric mixtures and preferably aromatic diisocyanates and polyisocyanates such as 2,4- and 2,6-toluene diisocyanate and the corresponding isomeric mixtures 4,4′-, 2,4′-, and 2,2′-diphenylmethane diisocyanate and the corresponding isomeric mixtures, mixtures of 4,4′-, 2,4′-, and 2,2-diphenylmethane diisocyanates and polyphenylenepolymethylene polyisocyanates (crude MDI), as well as mixtures of crude MDI and toluene diisocyanates. The organic di- and polyisocyanates can be used individually or in the form of mixtures. Particularly preferred for the production of rigid foams is crude MDI containing about 50 to 70 weight percent polyphenyl-polymethylene polyisocyanate and from 30 to 50 weight percent diphenylmethane diisocyanate, based on the weight of all polyisocyanates used. Frequently, so-called modified multivalent isocyanates, i.e., products obtained by the partial chemical reaction of organic diisocyanates and/or polyisocyanates are used. Examples include diisocyanates and/or polyisocyanates containing ester groups, urea groups, biuret groups, allophanate groups, carbodiimide groups, isocyanurate groups, and/or urethane groups. Specific examples include, but are not limitrd to: organic, preferably aromatic, polyisocyanates containing urethane groups and having an NCO content of 33.6 to 15 weight percent, preferably 31 to 21 weight percent, based on the total weight, e.g., with low molecular weight diols, triols, dialkylene glycols, trialkylene glycols, or polyoxyalkylene glycols with a molecular weight of up to 6000; modified 4,4′-diphenylmethane diisocyanate or 2,4- and 2,6-toluene diisocyanate, where examples of di- and polyoxyalkylene glycols that may be used individually or as mixtures include diethylene glycol, dipropylene glycol, polyoxyethylene glycol, polyoxypropylene glycol, polyoxyethylene glycol, polyoxypropylene glycol, and polyoxypropylene polyoxyethylene glycols or -triols. Prepolymers containing NCO groups with an NCO content of 29 to 3.5 weight percent, preferably 21 to 14 weight percent, based on the total weight and produced from the polyester polyols and/or preferably polyether polyols described below; 4,4′-diphenylmethane diisocyanate, mixtures of 2,4′- and 4,4′-diphenylmethane diisocyanate, 2,4,- and/or 2,6-toluene diisocyanates or polymeric MDI are also suitable. Furthermore, liquid polyisocyanates containing carbodiimide groups having an NCO content of 33.6 to 15 weight percent, preferably 31 to 21 weight percent, based on the total weight, have also proven suitable, e.g., based on 4,4′- and 2,4′- and/or 2,2′-diphenylmethane diisocyanate and/or 2,4′- and/or 2,6-toluene diisocyanate. The modified polyisocyanates may optionally be mixed together or mixed with unmodified organic polyisocyanates such as 2,4′- and 4,4′-diphenylmethane diisocyanate, polymeric MDI, 2,4′- and/or 2,6-toluene diisocyanate. The organic isocyanates used in the invention preferably have an average functionality of greater than 2, most preferably 2.5 or more. This provides for a greater crosslinking density in the resulting foam, which improves the dimensional stability of the foam.

Suitable polylols for reaction with the polyisocyanates include polyester polyols and polyether polyols. Examples of suitable polyester polyols include, but are not limited to those obtained, for example, from polycarboxylic acids and polyhydric alcohols. A suitable polycarboxylic acid may be used such as oxalic acid, malonic acid, succinic acid, glutaric acid, adipic acid, pimelic acid, suberic acid, azelaic acid, sebacic acid, brassylic acid, thapsic acid, maleic acid, fumaric acid, glutaconic acid, a-hydromuconic acid, beta-hydromuconic acid, a-butyl-a-ethyl-glutaric acid, alpha, beta-diethylsuccinic acid, isophthalic acid, terephthalic acid, phtalic acid, hemimellitic acid, and 1,4-cyclohexanedicarboxylic acid. A suitable polyhydric alcohol may be used such as ethylene glycol, propylene glycol, dipropylene glycol, trimethylene glycol, 1,2 butanediol, 1,5-pentanediol, 1,6-hexanediol, 1,7-heptanediol, hydroquinone, resorcinol glycerol, glycerine, 1,1,1-trimethylol-propane, 1,1,1-trimethylolethane, pentaerythritol, 1,2,6-hexanetriol, a-methyl glucoside, sucrose, and sorbitol. Also included within the term “polyhydric alcohol” are compounds derived from phenol such 2,2-bis(4-hydroxyphenol)-propane, commonly known as Bisphenol A.

The hydroxyl-containing polyester may also be a polyester amide such as is obtained by including some amine or amino alcohol in the reactants for the preparation of the polyesters. Thus, polyester amides may be obtained by condensing an amino alcohol such as ethanolamine with the polycarboxylic acids set forth above or they may be made using the same components that make up the hydroxyl-containing polyester with only a portion of the components being a diamine such as ethylene diamine. Another suitable polyester polyol useful as an additional polyester polyol is an alpha-methylglucoside initiated polyester polyol derived from polyethylene terephthalate. This polyol has a molecular weight of approximately 358, a hydroxyl number of about 360 meq polyol/g KOH and a nominal average functionality of 2.3.

As alluded to above, each of the polyols, including the polyester polyol, preferably has hydroxyl numbers of 200 or more meq polyol/g KOH. At hydroxyl numbers of less than 200, the dimensional stability of the foam may begin to deteriorate. The optimum nominal functionality of aromatic polyester polyol appears to be 2 or more, with an average hydroxyl numbers of 350 or more. Likewise, the optimum nominal functionality of each amine-initiated polyol appears to be 4 or more, with hydroxyl numbers of 400 or more.

Other polyols besides the polyester polyols described herein can be added to or employed as the polyol composition. Such polyols would include polyoxyalkylene polyether polyols, polythioether polyols, polyester amides and polyacetals containing hydroxyl groups, aliphatic polycarbonates containing hydroxyl groups, amine terminated polyoxyalkylene polyethers, polyester polyols, other polyoxyalkylene polyether polyols, and graft dispersion polyols. In addition, mixtures of at least two of the aforesaid polyols can be used. The preferable additional polyols are polyoxyalkylene polyether polyols. Included among polyoxyalkylene polyether polyols are polyoxyethylene polyols, polyoxypropylene polyols, polyoxybutylene polyols, polytetramethylene polyols, and block copolymers, for example combinations of polyoxypropylene and polyoxyethylene poly-1,2-oxybutylene and polyoxyethylene polyols, poly-1,4-tetramethylene and polyoxyethylene polyols, and copolymer polyols prepared from blends or sequential addition of two or more alkylene oxides. The polyoxyalkylene polyether polyols may be prepared by any known process such as, for example, the process disclosed by Wurtz in 1859 and Encyclopedia of Chemical Technology, Vol. 7, pp. 257-262, published by Interscience Publishers, Inc. (1951) or in U.S. Pat. No. 1,922,459. The alkylene oxides may be added to the initiator, individually, sequentially one after the other to form blocks, or in mixture to form a heteric polyether. The polyoxyalkylene polyether polyols may have either primary or secondary hydroxyl groups. The polyoxyalkylene polyether polyol may have aromatic amine-initiated or aliphatic amine-initiated polyoxyalkylene polyether polyols. It is preferred that at least one of the amine-initiated polyols are polyether polyols terminated with a secondary hydroxyl group through addition of, for example, propylene oxide as the terminal block. It is preferred that the amine-initiated polyols contain 50 weight percent or more, and up to 100 weight percent, of secondary hydroxyl group forming alkylene oxides, such as polyoxypropylene groups, based on the weight of all oxyalkylene groups. This amount can be measured by adding 50 weight percent or more of the secondary hydroxyl group forming alkylene oxides to the initiator molecule in the course of manufacturing the polyol. Suitable initiator molecules for the polyoxyalkylene polyether compounds are primary or secondary amines. These would include, for the aromatic amine-initiated polyether polyol, the aromatic amines such as aniline, N-alkylphenylene-diamines, 2,4′-, 2,2′-, and 4,4′-methylenedianiline, 2,6- or 2,4-toluenediamine, vicinal toluenediamines, o-chloro-aniline, p-aminoaniline, 1,5-diaminonaphthalene, methylene dianiline, the various condensation products of aniline and formaldehyde, and the isomeric diaminotoluenes, with preference given to vicinal toluenediamines. For the aliphatic amine-initiated polyol, any aliphatic amine, whether branched or unbranched, substituted or unsubstituted, saturated or unsaturated, may be used. These would include, as examples, mono-, di, and trialkanolamines, such as monoethanolamine, methylamine, triisopropanolamine; and polyamines such as ethylene diamine, propylene diamine, diethylenetriamine; or 1,3-diaminopropane, 1,3-diaminobutane, and 1,4-diaminobutane. Preferable aliphatic amines include any of the diamines and triamines, most preferably, the diamines. Preferably, the poyetherl polyols have number average molecular weights of 200-750 and nominal functionalities of 3 or more. By a nominal functionality, it is meant that the functionality expected is based upon the functionality of the initiator molecule, rather than the actual functionality of the final polyether after manufacture. The polyoxyalkylene polyether polyols may generally be prepared by polymerizing alkylene oxides with polyhydric amines. Any suitable alkylene oxide may be used such as ethylene oxide, propylene oxide, butylene oxide, amylene oxide, and mixtures of these oxides. The polyoxyalkylene polyether polyols may be prepared from other starting materials such as tetrahydrofuran and alkylene oxide-tetrahydrofuran mixtures; epihalohydrins such as epichlorohydrin; as well as aralkylene oxides such as styrene oxide. Other polyoxyalkylene polyether polyols may include those initiated with polyhydroxyl compounds. Examples of such initiators are trimethylolpropane, glycerine, sucrose, sorbitol, propylene glycol, dipropylene glycol, pentaerythritol, and 2,2-bis(4-hydroxyphenyl)-propane and blends thereof.

Also suitable are polymer modified polyols, in particular, the so-called graft polyols. Graft polyols are well known to the art and are prepared by the in situ polymerization of one or more vinyl monomers, preferably acrylonitrile and styrene, in the presence of a polyether polyol, particularly polyols containing a minor amount of natural or induced unsaturation. Methods of preparing such graft polyols may be found in columns 1-5 and in the Examples of U.S. Pat. No. 3,652,639; in columns 1-6 and the Examples of U.S. Pat. No. 3,823,201; particularly in columns 2-8 and the Examples of U.S. Pat. No. 4,690,956; and in U.S. Pat. No. 4,524,157; all of which patents are herein incorporated by reference. Non-graft polymer modified polyols are also suitable, for example, as those prepared by the reaction of a polyisocyanate with an alkanolamine in the presence of a polyether polyol as taught by U.S. Pat. Nos. 4,293,470; 4,296,213; and 4,374,209; dispersions of polyisocyanurates containing pendant urea groups as taught by U.S. Pat. No. 4,386,167; and polyisocyanurate dispersions also containing biuret linkages as taught by U.S. Pat. No. 4,359,541. Other polymer modified polyols may be prepared by the in situ size reduction of polymers until the particle size is less than 20 mm, preferably less than 10 mm. The average hydroxyl number of the polyols in the polyol composition should preferably be 200 meq polyol/g KOH or more and, more preferably 350 meq polyol/g KOH or more. Individual polyols may be used which fall below the lower limit, but the average should be within this range. Polyol compositions whose polyols are on average within this range make good dimensionally stable foams.

In addition to the foregoing, the composition of the present invention also includes at least one blowing agent. The blowing agent may be added and solubilized in the polyol composition for storage and later use in a foaming apparatus or may be added to a preblend tank in the foaming apparatus and preferably solubilized in the polyol composition immediately prior to pumping or metering the foaming ingredients to the mix head. Alternatively, the blowing agent may be added to the foaming ingredients in the mix head as a separate stream, although full solubility might be limited due to the short amount of time the blowing agent is exposed to the polyol composition in the mix head. The advantage of the polyol composition of the invention is that the polyol composition provides the flexibility of storing stable polyol compositions containing the desired blowing agent, or solubilizing the blowing agent with the polyol composition in the preblend tank, or adding it at the mix head, to manufacture a foam of the desired quality. The particular amount of blowing agent will depend in large part upon the desired density of the foam product. For most applications, polyurethane free rise densities for thermal insulation applications range from free rise densities of 0.5 to 40.0 pcf, preferably from 1.2 to 20.0 pcf. The preferred overall densities of foams packed to 10% by weight, meaning the percentage by weight of foam ingredients above the theoretical amount needed to fill the volume of the mold upon foaming, are from about 1.2 to about 20.0 pcf, more preferably from 1.5 to 6.0 pcf. The amount by weight of all blowing agents is generally, based on the weight of the polyol composition, from about 1.0 parts by weight to 60.0 parts by weight, and more preferably, 5.0 parts by weight to 40.0 parts by weight, most preferably from about 7.0 to about 25.0 parts by weight, based on 100 parts by weight of the polyol.

Any suitable blowing agent may be use in this invention. Such blowing agents include hydrofluorocarbons, perfluorinated hydrocarbons, and fluorinated ethers (collectively referred to herein as HFC's), hydrochlorofluorocarbons (HCFC's), hydrocarbons (HC's), chlorofluorocarbons (CFC's), hydrofluoroethers, alcohols, ethers, nitrogen, argon, carbon dioxide, water, formic acid, methyl formate, 2-chloropropane, trans-1,2-dichloroethlene, air, helium or other blowing agents typically used in the polymer foam industry and mixtures thereof. Suitable HFC blowing agents include difluoromethane (HFC-32); 1,1,1,2-tetrafluoroethane (HFC-134a); 1,1,2,2-tetrafluoroethane (HFC-134); 1,1-difluoroethane (HFC-152a); 1,2-difluoroethane (HFC-142), trifluoromethane; heptafluoropropane; 1,1,1-trifluoroethane; 1,1,2-trifluoroethane; 1,1,1,2,2-pentafluoropropane; 1,1,1,3,3-pentafluoropropane (HFC 245fa); 1,1,1,3-tetrafluoropropane; 1,1,2,3,3-pentafluoropropane; 1,1,1,3,3-pentafluoro-n-butane; 1,1,1,2,3,3,3-heptafluoropropane (HFC 227ea); hexafluorocyclopropane (C-216); octafluorocyclobutane (C-318); perfluorotetrahydrofuran; perfluoroalkyl tetrahydrofurans; perfluorofuran; perfluoro-propane, -butane, -cyclobutane, -pentane, -cyclopentane, and -hexane, -cyclohexane, -heptane, and -octane; perfluorodiethyl ether; perfluorodipropyl ether; and perfluoroethyl propyl ether. Preferred among the HFC blowing agents is 1,1,1,3,3-pentafluoropropane (HFC-145a).

Suitable HCFC blowing agents include, but are not limited to, 1-chloro-1,2-difluoroethane; 1-chloro-2,2-difluoroethane (142a); 1-chloro-1,1-difluoroethane (142b); 1,1-dichloro-1-fluoroethane (141b); 1-chloro-1,1,2-trifluoroethane; 1-chloro-1,2,2-trifluoroethane; 1,1-diochloro-1,2-difluoroethane; 1-chloro-1,1,2,2-tetrafluoroethane (124a); 1-chloro-1,2,2,2-tetrafluoroethane (124); 1,1-dichloro-1,2,2-trifluoroethane; 1,1-dichloro-2,2,2-trifluoroethane (123); and 1,2-dichloro-1,1,2-trifluoroethane (123a); monochlorodifluoromethane (HCFC-22); 1-chloro-2,2,2-trifluoroethane (HCFC-133a); gem-chlorofluoroethylene (R-1131a); chloroheptafluoropropane (HCFC-217); chlorodifluoroethylene (HCFC-1122); and trans-chlorofluoroethylene (HCFC-1131). Preferred among hydrochlorofluorocarbon blowing agents is 1,1-dichloro-1-fluoroethane (HCFC-141b). Other suitable blowing agents include butanes, pentanes, hexanes, alcohols, ethers, methyl formate, 2-chloropropane, trans-1,2-dichlotoethylene, mixtures thereof, etc.

Other blowing agents which can be used in addition to the blowing agents listed above may be divided into the chemically active blowing agents which chemically react with the isocyanate or with other formulation ingredients to release a gas for foaming, and the physically active blowing agents which are gaseous at the exothermic foaming temperatures or less without the necessity for chemically reacting with the foam ingredients to provide a blowing gas. Included within the meaning of physically active blowing agents are those gases which are thermally unstable and decompose at elevated temperatures. Examples of chemically active blowing agents are preferentially those which react with the isocyanate to liberate gas, such as CO₂. Suitable chemically active blowing agents include, but are not limited to, water, mono- and polycarboxylic acids having a molecular weight of from 46 to 300, salts of these acids, and tertiary alcohols. Water is preferentially used as a blowing agent. Water reacts with the organic isocyanate to liberate CO₂ gas which is the actual blowing agent. However, since water consumes isocyanate groups, an equivalent molar excess of isocyanate must be used to make up for the consumed isocyanates. Water is typically found in minor quantities in the polyols as an impurity and may be sufficient to provide the desired blowing activity from a chemically active substance. Preferably, however, water is additionally introduced into the polyol composition in amounts of from about 0.02 to 5 weight percent, preferably from 0.05 to 4 parts by weight, based on 100 parts by weight of the polyol. The organic carboxylic acids used are advantageously aliphatic mono- and polycarboxylic acids, e.g. dicarboxylic acids. However, other organic mono- and polycarboxylic acids are also suitable. The organic carboxylic acids may, if desired, also contain substituents which are inert under the reaction conditions of the polyisocyanate polyaddition or are reactive with isocyanate, and/or may contain olefinically unsaturated groups. Specific examples of chemically inert substituents are halogen atoms, such as fluorine and/or chlorine, and alkyl, e.g., methyl or ethyl. The substituted organic carboxylic acids expediently contain at least one further group which is reactive toward isocyanates, e.g., a mercapto group, a primary and/or secondary amino group, or preferably a primary and/or secondary hydroxyl group. Suitable carboxylic acids are thus substituted or unsubstituted monocarboxylic acids, e.g., formic acid, acetic acid, propionic acid, 2-chloropropionic acid, 3-chloropropionic acid, 2,2-dichloropropionic acid, hexanoic acid, 2-ethyl-hexanoic acid, cyclohexanecarboxylic acid, dodecanoic acid, palmitic acid, stearic acid, oleic acid, 3-mercapto-propionic acid, glycolic acid, 3-hydroxypropionic acid, lactic acid, ricinoleic acid, 2-aminopropionic acid, benzoic acid, 4-methylbenzoic acid, salicylic acid and anthranilic acid, and unsubstituted or substituted polycarboxylic acids, preferably dicarboxylic acids, e.g., oxalic acid, malonic acid, succinic acid, fumaric acid, maleic acid, glutaric acid, adipic acid, sebacic acid, dodecanedoic acid, tartaric acid, phthalic acid, isophthalic acid and citric acid.

Catalysts may be employed which greatly accelerate the reaction of the compounds containing hydroxyl groups and with the modified or unmodified polyisocyanates. Examples of suitable compounds are cure catalysts which also function to shorten tack time, promote green strength, and prevent foam shrinkage. Suitable cure catalysts are organometallic catalysts, preferably organotin catalysts, although it is possible to employ metals such as lead, titanium, copper, mercury, cobalt, nickel, iron, vanadium, antimony, and manganese. Suitable organometallic catalysts, exemplified here by tin as the metal, are represented by the formula: RₙSn[X—R¹—Y]₂, wherein R is a C₁₋₈ alkyl or aryl group, R¹ is a C₀₋₁₈ alkylene group optionally substituted or branched with a C1₋₄ alkyl group, Y is hydrogen or a hydroxyl group, preferably hydrogen, X is methylene, an —S—, an —SR²COO—, —SOOC—, an —O_{0.3}S—, or an —OOC— group wherein R is a C₁₋₄ alkyl, n is 0 or 2, provided that R¹ is C_{0.0} only when X is a methylene group. Specific examples are tin (II) acetate, tin (II) octanoate, tin (II) ethylhexanoate and tin (II) laurate; and dialkyl (1-8C) tin (IV) salts of organic carboxylic acids having 1-32 carbon atoms, preferably 1-20 carbon atoms, e.g., diethyltin diacetate, dibutyltin diacetate, dibutyltin diacetate, dibutyltin dilaurate, dibutyltin maleate, dihexyltin diacetate, and dioctyltin diacetate. Other suitable organotin catalysts are organotin alkoxides and mono or polyalkyl (1-8C) tin (IV) salts of inorganic compounds such as butyltin trichloride, dimethyl- and diethyl- and dibutyl- and dioctyl- and diphenyl-tin oxide, dibutydtin dibutoxide, di(2-ethylhexyl)tin oxide, dibutyltin dichloride, and dioctyltin dioxide.

Tertiary amines also promote urethane linkage formation, and include triethylamine, 3-methoxypropyldimethylamine, triethylenediamine, tributylamine, dimethylbenzylamine, N-methyl-, N-ethyl- and N-cyclohexylmorpholine, N,N,N′,N′-tetramethylethylenediamine, N,N,N′,N′-tetramethylbutanediamin or -hexanediamine, N,N,N′-trimethyl isopropyl propylenediamine, pentamethyldiethylenetriamine, tetramethyldiaminoethyl ether, bis(dimethylaminopropyl)urea, dimethylpiperazine, 1-methyl-4-dimethylaminoethylpiperazine, 1,2-dimethylimidazole, 1,2-azabicylo[3.3.0]octane and preferably 1,4-diazabicylo[2.2.2]octane, and alkanolamine compounds, such as triethanolamine, trisopropanolamine, N-methyl- and N-ethyldiethanolamine and dimethylethanolamine.

To prepare the polyisocyanurate foams, a polyisocyanurate catalyst is employed. Suitable polyisocyanurate catalysts are alkali salts, for example, sodium salts, preferably potassium salts and ammonium salts, of organic carboxylic acids, expediently having from 1 to 8 carbon atoms, preferably 1 or 2 carbon atoms, for example, the salts of formic acid, acetic acid, propionic acid, or octanoic acid, and tris(dialkylaminoethyl)-, tris(dimethylaminopropyl)-, tris(dimethylaminobutyl)- and the corresponding tris(diethylaminoalkyl)-s-hexahydrotriazines. However, (trimethyl-2-hydroxypropyl)ammonium formate, (trimethyl-2-hydroxypropyl)ammonium octanoate, potassium acetate, potassium octoate potassium formate and tris(dimethylaminopropyl)-s-hexahydrotriazine are polyisocyanurate catalysts which are generally used. The suitable polyisocyanurate catalyst is usually used in an amount of from 1 to 10 parts by weight, preferably from 1.5 to 8 parts by weight, based on 100 parts by weight of the total amount of polyols.

Urethane-containing foams may be prepared with or without the use of chain extenders and/or crosslinking agents, which are not necessary in this invention to achieve the desired mechanical hardness and dimensional stability. The chain extenders and/or crosslinking agents used have a number average molecular weight of less than 400, preferably from 60 to 300; or if the chain extenders have polyoxyalkylene groups, then having a number average molecular weight of less than 200. Examples are dialkylene glycols and aliphatic, cycloaliphatic and/or araliphatic diols having from 2 to 14 carbon atoms, preferably from 4 to 10 carbon atoms, e.g., ethylene glycol, 1,3-propanediol, 1,10-decanediol, o-, m-, and p-dihydroxycyclohexane, diethylene glycol, dipropylene glycol, and preferably 1,4-butanediol, 1,6-hexanediol, bis(2-hydroxyethyl)hydroquinone, triols such as 1,2,4- and 1,3,5-trihydroxycyclohexane, glycerol, and trimethylolpropane.

Polyurethane foams can also be prepared by using secondary aromatic diamines, primary aromatic diamines, 3,3′-di- and/or 3,3′-, 5,5′-tetraalkyl-substituted diaminodiphenylmethanes as chain extenders or crosslinking agents instead of or mixed with the above-mentioned diols and/or triols. The amount of chain extender, crosslinking agent or mixture thereof used, if any, is expediently from 2 to 20 percent by weight, preferably from 1 to 15 percent by weight, based on the weight of the polyol composition. However, as previously alluded to, it is preferred that no chain extender/crosslinker is used for the preparation of rigid foams since the polyether polyols described above are sufficient to provide the desired mechanical properties.

If desired, additives can be incorporated into the reaction mixture for the production of the cellular plastics by the polyisocyanate polyaddition process. Specific examples include surfactants, foam stabilizers, cell regulators, fillers, dyes, pigments, flame-proofing agents, hydrolysis-protection agents, and fungistatic and bacteriostatic substances.

Examples of suitable surfactants are compounds which serve to regulate the cell structure of the plastics by helping to control the cell size in the foam and reduce the surface tension during foaming via reaction of the polyol composition with an organic isocyanate as described herein. Specific examples are salts of sulfonic acids, e.g., alkali metal salts or ammonium salts of dodecylbenzene- or dinaphthylmethanedisulfonic acid and ricinoleic acid; foam stabilizers, such as siloxane-oxyalkylene copolymers and other organopolysiloxanes, oxyethylated alkyl-phenols, oxyethylated fatty alcohols, paraffin oils, castor oil esters, ricinoleic acid esters, Turkey red oil and groundnut oil, and cell regulators, such as paraffins, fatty alcohols, and dimethylpolysiloxanes. The surfactants are usually used in amounts of 0.01 to 5 parts by weight, based on 100 parts by weight of the polyol component.

For the purposes of the invention, other fillers other than the functionalized nano-scaled particles may, if desired, be employed. Such fillers are conventional organic and inorganic fillers and reinforcing agents. Specific examples are inorganic fillers, such as silicate minerals, for example, phyllosilicates such as antigorite, serpentine, hornblends, amphiboles, chrysotile, and talc; metal oxides, such as kaolin, aluminum oxides, titanium oxides and iron oxides; metal salts, such as chalk, barite and inorganic pigments, such as cadmium sulfide, zinc sulfide and glass, inter alia; kaolin (china clay), aluminum silicate and co-precipitates of barium sulfate and aluminum silicate, and natural and synthetic fibrous minerals, such as wollastonite, metal, and glass fibers of various lengths. Examples of suitable organic fillers are carbon black, melamine, colophony, cyclopentadienyl resins, cellulose fibers, polyamide fibers, polyacrylonitrile fibers, polyurethane fibers, and polyester fibers based on aromatic and/or aliphatic dicarboxylic acid esters, and in particular, carbon fibers. The inorganic and organic fillers may be used individually or as mixtures and may be introduced into the polyol composition or isocyanate side in amounts of from 0.5 to 40 percent by weight, based on the weight of components (the polyol composition and the isocyanate).

Examples of suitable flameproofing agents are tricresyl phosphate, tris(2-chloroethyl)phosphate, tris(2-chloropropyl)phosphate, and tris(2,3-dibromopropyl)phosphate. In addition to the above-mentioned halogen-substituted phosphates, it is also possible to use inorganic or organic flameproofing agents, such as red phosphorus, aluminum oxide hydrate, antimony trioxide, arsenic oxide, ammonium polyphosphate (Exolit.RTM) and calcium sulfate, expandable graphite or cyanuric acid derivatives, e.g., melamine, or mixtures of two or more flameproofing agents, e.g., ammonium polyphosphates and melamine, and, if desired, corn starch, or ammonium polyphosphate, melamine, and expandable graphite and/or, if desired, aromatic polyesters, in order to flameproof the polyisocyanate polyaddition products. In general, from 2 to 50 parts by weight, preferably from 5 to 25 parts by weight, of said flameproofing agents may be used per 100 parts by weight of the polyol composition.

Further details on the other conventional assistants and additives mentioned above can be obtained from the previously mentioned monograph by J. H. Saunders and K. C. Frisch, High Polymers, Volume XVI, Polyurethanes, Parts 1 and 2, Interscience Publishers 1962 and 1964, respectively, or Kunststoff-Handbuch, Polyurethane, Volume VII, Carl-Hanser-Verlag, Munich, Vienna, 1st and 2nd Editions, 1966 and 1983.

The foams produced by the process according to the invention can be flexible or rigid. The rigid and the corresponding structural foams are used, for example, in the vehicle industry (the automotive, aircraft, and ship building industries) and in the furniture and sports goods industries. They are particularly suitable in the construction, transportation, packaging and refrigeration sectors as thermal insulators, for example, as intermediate layers for laminate board or for foam-filling appliances such as refrigerators, freezer housings, tanks, pipes, and picnic coolers. The foams also find use in marine, decorative products, bedding carpet cushions, panels, doors board stock and the like. For pour-in-place applications, the rigid foam may be poured or injected to form a sandwich structure of a first substrate/foam/second substrate or may be laminated over a substrate to form a substrate foam structure. The first and second substrate may each be independently made of the same material or of different materials, depending upon the end use. Suitable substrate materials comprise metal such as aluminum, tin, or formed sheet metal such as used in the case of refrigeration cabinets; wood, including composite wood; acrylonitrile-butadiene-styrene (ABS) triblock of rubber, optionally modified with styrene-butadiene diblock, styrene-ethylene/butylene-styrene triblock, optionally functionalized with maleic anhydride and/or maleic acid, polyethylene terephthalate, polycarbonate, polyacetals, rubber modified high impact polystyrene (HIPS), blends of HIPS with polyphenylene oxide, copolymers of ethylene and vinyl acetate, ethylene and acrylic acid, ethylene and vinyl alcohol, homopolymers or copolymers of ethylene and propylene such as polypropylene, high density polyethylene, high molecular weight high density polyethylene, polyvinyl chloride, nylon 66, or amorphous thermoplastic polyesters. Preferred are aluminum, tin, ABS, HIPS, polyethylene, and high density polyethylene. The polyurethane foam may be contiguous to and bonded to the inner surfaces of the first and second substrates, or the polyurethane foam may be contiguous to a layer or lamina of synthetic material interposed between the substrates. Thus, the sequence of layers in the composite may also comprise a first substrate/polyurethane foam/layer or lamina/second substrate or first substrate/layer or lamina/polyurethane foam/layer or lamina/second substrate. The layer or lamina of layers additionally interposed into the composite may comprise any one of the above-mentioned synthetic resins which have good elongation such as low density polyethylene or low density linear polyethylene as a stress relief layer or a material which promotes adhesion between the polyurethane foam and the first and/or second substrate of choice.

Illustrative, but by no means exhaustive, of the advantages obtained by the incorporation of the functionalized nano-scaled materials into isocyanate-besed polymeric formulation are the advantages demonstrated by the following examples of a formulation of this invention and a comparative formulation without the functionalized nano-scaled material. The isocyanate-based foamable formulation employed in this comparative testing was the following formulation in which, for the formulation of the invention the functionalized nano-scaled material was incorporated into the polyol preblend.

| Component (parts by | Comparative | Invention |
|---|---|---|
| weight) | Formulation | Formulation |
| Polyether Polyol #1 | 67.8 | 67.8 |
| Polyester Polyol | 20 | 20 |
| Amine Polyol | 7.6 | 7.6 |
| Polyether Polyol #2 | 4.6 | 4.6 |
| Surfactant | 1 | 1 |
| Catalyst | 1.8 | 1.8 |
| Flame Retardant | 12.0 | 12.0 |
| Water | 0.5 | 0.5 |
| Synthetic organoclay V | 0.0 | 1.0 |
| Somasif MPE nano | | |
| particles | | |
| Blowing Agent HFC-245fa | 35.3 | 35.3 |
| Isocyanate | 202.8 | 202.8 |
| Index | 110 | 110 |

Foams were prepared from these formulations by mixing the polyol preblend with the isocyanate and the properties of the resulting foams determined. The resulting foam properties were as follows.

| | Comparative | Inventive |
|---|---|---|
| Property | Formulation | Formulation |
| Initial K BTU in/hr ft² ° F. | | |
| 40° F. | 0.1320 | 0.1285 |
| 75° F. | 0.1482 | 0.1428 |
| 110° F. | 0.1662 | 0.1599 |
| 6 months K BTU in/hr ft² ° F. | | |
| 40° F. | 0.1653 | 0.1585 |
| 75° F. | 0.1840 | 0.1749 |
| 110° F. | 0.2042 | 0.1935 |
| Dimensional Stability Vol % | | |
| 70° C./95% RH | | |
| 28 days | 27.7 | 18.6 |
| Compressive Strength psi | | |
| Parallel | 26.6 | 30.8 |
| Perpendicular | 12.5 | 13.1 |

The inventive formulation with the functionalized nano-scaled material showed improvement in all three measured properties, namely initial k-factor, dimensional stability and compressive strength. Compared to the formulation without the functionalized nano-scaled material.

While the invention has been described herein with reference to the specific embodiments thereof, it will be appreciated that changes, modification and variations can be made without departing from the spirit and scope of the inventive concept disclosed herein. Accordingly, it is intended to embrace all such changes, modification and variations that fall with the spirit and scope of the appended claims.

We claim:

1. An isocyanate-based formulation for forming a isocyanate-based foam, said formulation containing functionalized nano-scale material, wherein the nano-scale material is functionalized with functional groups selected from OH, NH₂, COOH and NCO functional groups.

2. An isocyanate-based formulation according to claim 1 wherein the functionalized nano-scale material is a synthetic organoclay material.

3. An isocyanate-based formulation according to claim 2 wherein the synthetic organoclay is functionalized with OH groups.

4. An isocyanate-based formulation according to claim 3 wherein the functionalized nano-scale material comprises from about 0.1 to about 10 wt % of the formulation.

5. An isocyanate-based formulation according to claim 1 comprising a blowing agent, the blowing agent being selected from the group consisting of hydrofluorocarbons (HFC's), hydrocarbons (HC's), hydrochlorofluorocarbons (HCFC's), water, organic acids, carbon dioxide, and methyl formate,

6. An isocyanate-based formulation according to claim 5 wherein the blowing agent is selected from the group consisting of 1,1,1,3,3-pentafluoropropane (245fa), butanes, pentanes, hexanes, water and methyl formate.

7. An isocyanate-based polymeric foam containing functionalized nano-scale material, wherein the nano-scale material is functionalized with functional groups selected from OH, NH₂, COOH and NCO functional groups.

8. An isocyanate-based polymeric foam according to claim 7 wherein the functionalized nano-scale material is a synthetic organoclay material.

9. An isocyanate-based polymeric foam according to claim 8 wherein the synthetic organoclay is functionalized with OH groups.

10. An isocyanate-based polymeric foam according to claim 9 wherein the functionalized nano-scale material comprises from about 0.1 to about 10 wt % of the foam.

11. An isocyanate-based polymeric foam according to claim 7 which is a polyurethane foam.

12. An isocyanate-based polymeric foam according to claim 7 which is a polyisocyanurate foam.

13. A polyol preblend for producing an isocyanate-based polymeric foam formulation, said polyol preblend containing polyol and functionalized nano-scale material, wherein the nano-scale material is functionalized with functional groups selected from OH, NH₂, COOH and NCO functional groups.

14. A polyol preblend according to claim 13 wherein the functionalized nano-scale material is a synthetic organoclay material.

15. A polyol preblend according to claim 14 wherein the synthetic organoclay material is functionalized with OH groups.

16. A polyol preblend according to claim 15 wherein the functionalized nano-scale material comprises from about 0.2 to about 20 wt % of the polyol preblend.

17. A polyol preblend according to claim 13 comprising a blowing agent, the blowing agent being selected from the group consisting of hydrofluorocarbons (HFC's), hydrocarbons (HC's), hydrochlorofluorocarbons (HCFC's), water, organic acids, carbon dioxide, and methyl formate,

18. A polyol preblend according to claim 17 wherein the blowing agent is selected from the group consisting of 1,1,1,3,3-pentafluoropropane (245fa), butanes, pentanes, hexanes, water and methyl formate.

19. A process for producing an isocyanate-based polymeric foam comprising reacting one or more polyols with one or more polyisocyanates and a blowing agent in the presence of functionalized nano-scale material, wherein the functionalized nano-scale material is functionalized with functional groups selected from the group consisting of OH, NH₂, COOH and NCO groups.

20. A process according to claim 19 wherein the functionalized nano-scale material is a synthetic organoclay material.

21. A process according to claim 20 wherein the synthetic organoclay is functionalized with OH groups.

22. A process according to claim 21 wherein the functionalized nano-scale material comprises from about 0.1 to about 10 wt % of the polymeric foam.

23. A process according to claim 19 wherein the blowing agent is selected from the group consisting of hydrofluorocarbons (HFC's), hydrocarbons (HC's), hydrochlorofluorocarbons (HCFC's), water, organic acids, carbon dioxide, and methyl formate,

24. A process according to claim 23 wherein the blowing agent is selected from the group consisting of 1,1,1,3,3-pentafluoropropane (245fa), butanes, pentanes, hexanes, water and methyl formate.

25. A process according to claim 19 for producing a polyurethane foam.

26. A process according to claim 19 for producing a polyisocyanurate foam.
